(19) United States
(12) Patent Application Publication
(10) Pub. No.: US 2021/0356437 A1
(43) Pub. Date: Nov. 18, 2021

(54) SCANNING APPARATUS

(71) Applicant: DolphiTech AS, Gjøvik (NO)

(72) Inventors: Eskil Skoglund, Gjøvik (NO); Øystein Knauserud, Gjøvik (NO); Fredrik Lingvall, Gjøvik (NO)

(21) Appl. No.: 17/288,880

(22) PCT Filed: Oct. 11, 2019
(86) PCT No.: PCT/EP2019/077660

§ 371 Date: Apr. 26, 2021

(30) Foreign Application Priority Data
Oct. 26, 2018 (GB) GB 1817503.4

(51) Int. Cl. G01N 29/24; B06B 1/06; G01N 29/34

(52) U.S. Cl. CPC G01N 29/2437; G01N 29/069; G01N 29/343; B06B 1/0688

(57) ABSTRACT

A scanning apparatus for imaging an object, the scanning apparatus comprising: an ultrasound transducer comprising a transmitter structure configured to transmit ultrasound signals in a first direction towards an object and a receiver structure configured to receive reflected ultrasound signals from an object; in which the transmitter structure comprises a first transmitting element and a second transmitting element, the first and second transmitting elements being spatially offset in the first direction.

### CROSS-REFERENCE TO RELATED APPLICATIONS

The present application is the national stage entry of International Patent Application No. PCT/EP2019/077660, filed on Oct. 11, 2019, and claims priority to Application No. GB 1817503.4, filed in the United Kingdom on Oct. 26, 2018, the disclosures of which are expressly incorporated herein in its entirety by reference thereto.

### FIELD OF THE INVENTION

The present invention relates to a scanning apparatus for imaging an object, in particular to a scanning apparatus comprising an ultrasound transducer. In particular, the scanning apparatus can be used for imaging structural features below an object's surface.

### BACKGROUND

The scanning apparatus may be particularly useful for imaging sub-surface material defects such as delamination, debonding and flaking.

Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled.

Ultrasound can also be used to scan a physical object. Most ultrasound frequencies are attenuated strongly by air and air-object boundaries tend to show a big impedance mismatch. Some form of coupling medium is needed if the ultrasound signals are to penetrate the object sufficiently. Often the coupling medium is a liquid, such as water or some form of gel.

Ultrasound can be used to identify particular structural features in an object. For example, ultrasound may be used for non-destructive testing by detecting the size and position of flaws in a sample. There are a wide range of applications that can benefit from non-destructive testing, covering different materials, sample depths and types of structural feature, such as different layers in a laminate structure, impact damage, boreholes etc. Therefore, there is a need for a scanning apparatus that is capable of performing well in a wide-range of different applications.

### SUMMARY

According to an aspect of the present invention, there is provided a scanning apparatus for imaging an object, the scanning apparatus comprising:
an ultrasound transducer comprising a transmitter structure configured to transmit ultrasound signals in a first direction towards an object and a receiver structure configured to receive reflected ultrasound signals from an object;
in which the transmitter structure comprises a first transmitting element and a second transmitting element, the first and second transmitting elements being spatially offset in the first direction.

The receiver structure may comprise a first receiving element and a second receiving element, the first and second receiving elements being spatially offset in the first direction. Each transmitting element may comprise a layer of piezoelectric material and a conducting material for conducting drive signals to the transmitting element. The conducting material of the transmitting element may be coupled to a signal driver for driving the piezoelectric material thereby to generate an ultrasound signal.

Each receiving element may comprise a layer of piezoelectric material and a conducting material for conducting received signals from the receiver element. The conducting material of the receiving element may be coupled to a signal processor for processing of the received signals.

The transducer may comprise a plurality of transducer elements, each of the transducer elements comprising a respective one of the plurality of transmitting elements. Each of the transducer elements may comprise a respective one of the plurality of receiving elements. The transmitting element and receiving element of one or more of the plurality of transducer elements may comprise a common layer of piezoelectric material. The layer of piezoelectric material may comprise polyvinylidene fluoride (PVDF).

An insulating layer may be provided between each successive transmitting element in the transmitter structure. The insulating layer may comprise polyimide.

The scanning apparatus may further comprise a coupling material for coupling ultrasound signals from the scanning apparatus into and out of an object. The coupling material may comprise an elastomer. The coupling material may comprise one or more of: a thermoplastic polymer; and a cross-linked polymer.

The scanning apparatus may comprise a seal for sealing between the coupling material and the transducer.

The scanning apparatus may further comprise delay circuitry configured to delay the transmission of an ultrasound signal. The delay circuitry may be configured to delay a trigger signal configured to cause a transmitting element to transmit an ultrasound signal.

The scanning apparatus may be configured to delay the transmission of an ultrasound signal from a transmitting element closer to the front of the transducer compared to the transmission of an ultrasound signal from a transmitting element further from the front of the transducer.

The transmitter structure may comprise a plurality of layers of transmitting elements configured to couple to a single signal driver. The transmitter structure may comprise a plurality of layers of transmitting elements, in which each layer of the plurality of layers is configured to couple to a respective signal driver.

The scanning apparatus may be configured to transmit energy down to 0.5 MHz.

The scanning apparatus may comprise a flexible transmitter circuit having a transmitter circuit connector and a flexible receiver circuit having a receiver circuit connector, the flexible transmitter circuit comprising the first transmitting element; and a plurality of circuits for coupling to the flexible circuits, each circuit comprising a respective circuit connector; in which the transmitter circuit connector is configured to engage with a first circuit connector of a first circuit of the plurality of circuits and the receiver circuit connector is configured to engage with a second circuit connector of a second circuit of the plurality of circuits.

The first circuit and the second circuit may be coupled together. The scanning apparatus may comprise a heat sink, and at least the first circuit of the plurality of circuits may be provided adjacent the heat sink. The first circuit connector may be provided on a side of the first circuit facing away from the heat sink.

At least one of the transmitter circuit connector and the receiver circuit connector may comprise a series of pads to enable electrical connection with conducting lines of the respective flexible circuit, the pads being provided in a staggered layout on the respective connector.

Flexible circuit connectors of a plurality of flexible circuits may be configured to engage simultaneously with a single circuit connector. The flexible circuit connectors of the plurality of flexible circuits may be laminated together, the laminated portion being configured to engage with the single circuit connector.

Any one or more feature of any aspect above may be combined with any other aspect. These have not been written out in full here merely for the sake of brevity.

### BRIEF DESCRIPTION OF THE FIGURES

The present invention will now be described by way of example with reference to the accompanying drawings. In the drawings:

FIG. 1 shows a device for imaging an object;

FIG. 2 shows an example of a scanning apparatus and an object;

FIG. 3 shows an example of the functional blocks of a scanning apparatus;

FIG. 4 shows an example structure of a multilayer scanning apparatus;

FIG. 5 shows another example structure of a multilayer scanning apparatus;

FIG. 6 shows a schematic example of delaying pulses;

FIG. 7 shows an example of transducer elements in a single layer transducer;

FIG. 8 shows an example of transducer elements in a dual layer transducer;

FIG. 9 shows an example of transducer elements in a quad layer transducer;

FIG. 10 shows an example of a transducer module;

FIG. 11a shows an exploded plan view of an example of a transducer module;

FIG. 11b shows a side view of the transducer module of FIG. 11a;

FIG. 12 shows an example of two circuits;

FIGS. 13a and 13b show example layouts of connecting pads;

FIGS. 14a and 14b shows examples of flex circuits;

FIG. 14c shows the flex circuits of FIGS. 14a and 14b overlaid;

FIGS. 15a to 15d show examples of four flex circuits;

FIG. 16 shows another example layout of connecting pads;

FIG. 17 shows an exploded plan view of another example of a transducer module;

FIG. 18 shows an example of four circuits;

FIGS. 19a to 19h show examples of eight flex circuits;

FIG. 20 shows the flex circuits of FIGS. 19a to 19h overlaid;

FIG. 21 shows an example circuit connector;

FIGS. 22a to 22d show examples of flex circuit connectors; and

FIG. 23 shows another example arrangement of flex circuit connectors.

### DETAILED DESCRIPTION

A scanning apparatus may gather information about structural features located different depths below the surface of an object. One way of obtaining this information is to transmit sound pulses at the object and detect any reflections. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure the operator wants to look at is beneath the object's surface. It is therefore important that the information is imaged in such a way that the operator can evaluate the object's structure effectively. To achieve this the scanning apparatus is preferably capable of generating ultrasound of a desired frequency to image the object.

Ultrasound transducers make use of a piezoelectric material, which is driven by electrical signals to cause the piezoelectric material to vibrate, generating the ultrasound signal. Conversely, when a sound signal is received, it causes the piezoelectric material to vibrate, generating electrical signals which can be detected. A given type of piezoelectric material will, in a given configuration, have a certain frequency response.

For example, a piezoelectric material such as polyvinylidene fluoride (PVDF) will typically have a frequency response in the range 2-15 MHz. The PVDF will typically generate signals in this broadband energy spectrum. A transducer constructed using PVDF as the active ultrasound generating layer will be unlikely to exhibit this full frequency response. A typical transducer that makes use of PVDF may have a peak frequency response of approximately 10 MHz. Such a transducer can sense many different material thicknesses.

The frequency response of the transducer can be tailored to some extent, but is unlikely in a practical implementation to go much below approximately 3.8 MHz.

The higher the frequency of the ultrasound signal, the shorter its wavelength, and the greater the likely absorption and/or attenuation as the signal enters an object to be imaged. This has the effect that higher frequency ultrasound is less penetrating than lower frequency ultrasound, and is more appropriate for imaging features that are closer to the surface of the object.

Conversely, lower frequency ultrasound is able to penetrate deeper into the object, and can reveal information over a greater depth range than can higher frequency ultrasound.

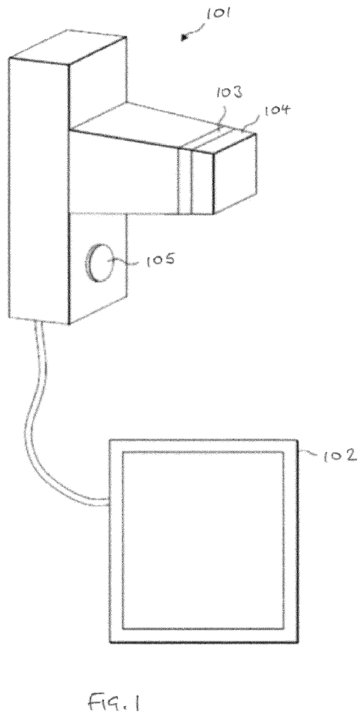

An example of a handheld device, such as a scanning apparatus described herein, for imaging below the surface of an object is shown in FIG. 1. The device 101 could have an integrated display, but in this example it outputs images to a tablet computer 102. The connection with the tablet could be wired, as shown, or wireless. The device has a matrix array 103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus as illustrated comprises a coupling layer such as a dry coupling layer 104 for coupling ultrasound signals into the object. The coupling layer also delays the ultrasound signals to allow time for the transducers to switch from transmitting to receiving. A dry coupling layer offers a number of advantages over other imaging systems, which tend to use liquids for coupling the ultrasound signals. This can be impractical in an industrial environment. If the liquid coupler is contained in a bladder, as is sometimes used, this makes it difficult to obtain accurate depth measurements which is not ideal for non-destructive testing applications. The coupling layer need not be provided in all examples.

The matrix array 103 is two dimensional so there is no need to move it across the object to obtain an image. A typical matrix array might be 30 mm by 30 mm but the size and shape of the matrix array can be varied to suit the application. The device may be straightforwardly held against the object by an operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 105 or other user input device that the operator can use to change the pulse shape and corresponding filter. The most appropriate pulse shape may depend on the type of structural feature being imaged and where it is located in the object. The operator can view the object at different depths by adjusting the time-gating via the display. Having the apparatus output to a handheld display, such as the tablet 102, or to an integrated display, is advantageous because the operator can readily move the transducer over the object, or change the settings of the apparatus, depending on what is seen on the display and get instantaneous results. In other arrangements, the operator might have to walk between a non-handheld display (such as a PC) and the object to keep rescanning it every time a new setting or location on the object is to be tested.

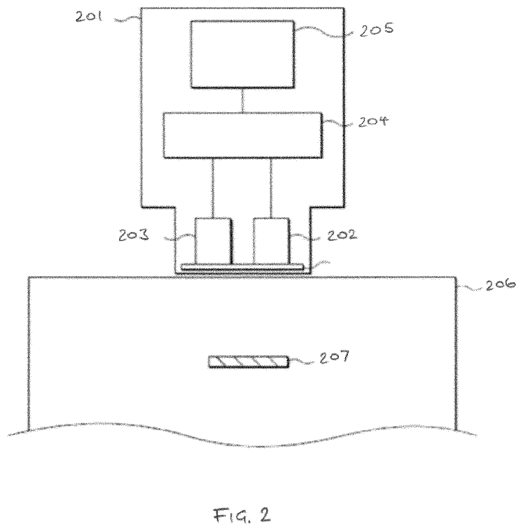

A scanning apparatus for imaging structural features below the surface of an object is shown in FIG. 2. The apparatus, shown generally at 201, comprises a transmitter 202, a receiver 203, a signal processor 204 and an image generator 205. In some examples the transmitter and receiver may be implemented by an ultrasound transducer. The transmitter and receiver are shown next to each other in FIG. 2 for ease of illustration only. The transmitter 202 is suitably configured to transmit a sound pulse having a particular shape at the object to be imaged 206. The receiver 203 is suitably configured to receive reflections of transmitted sound pulses from the object. A sub-surface feature of the object is illustrated at 207.

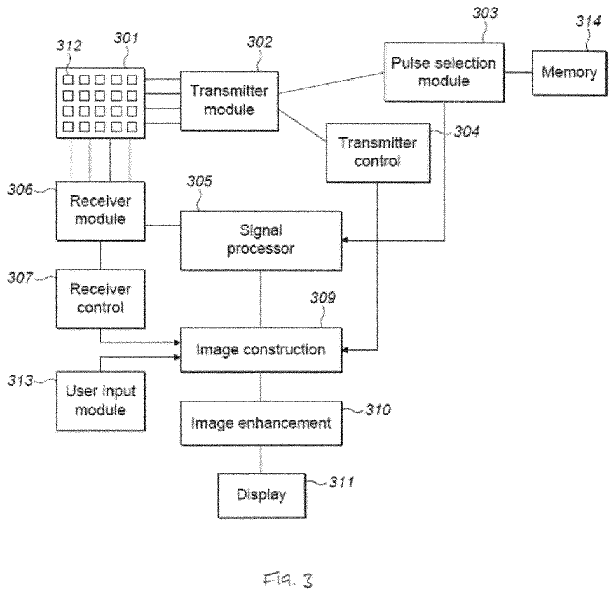

An example of the functional blocks comprised in one embodiment of the apparatus are shown in FIG. 3.

In this example the transmitter and receiver are implemented by an ultrasound transducer 301, which comprises a matrix array of transducer elements 312. The transducer elements transmit and/or receive ultrasound waves. The matrix array may comprise a number of parallel, elongated electrodes arranged in an intersecting pattern; the intersections form the transducer elements. The transmitter electrodes are connected to the transmitter module 302, which supplies a pulse pattern with a particular shape to a particular electrode. The transmitter control 304 selects the transmitter electrodes to be activated. The number of transmitter electrodes that are activated at a given time instant may be varied. The transmitter electrodes may be activated in turn, either individually or in groups. Suitably the transmitter control causes the transmitter electrodes to transmit a series of sound pulses into the object, enabling the generated image to be continuously updated. The transmitter electrodes may also be controlled to transmit the pulses using a particular frequency. The frequency may be between 100 kHz and 30 MHz, preferably it is between 0.5 MHz and 15 MHz and most preferably it is between 0.5 MHz and 10 MHz.

The receiver electrodes sense sound waves that are emitted from the object. These sound waves are reflections of the sound pulses that were transmitted into the object. The receiver module receives and amplifies these signals. The signals are sampled by an analogue-to-digital converter. The receiver control suitably controls the receiver electrodes to receive after the transmitter electrodes have transmitted. The apparatus may alternately transmit and receive. In one embodiment the electrodes may be capable of both transmitting and receiving, in which case the receiver and transmitter controls will switch the electrodes between their transmit and receive states. There is preferably some delay between the sound pulses being transmitted and their reflections being received at the apparatus. The apparatus may include a coupling layer to provide the delay needed for the electrodes to be switched from transmitting to receiving. Any delay may be compensated for when the relative depths are calculated. The coupling layer preferably provides low damping of the transmitted sound waves.

Each transducer element may correspond to a pixel in the image. In other words, each pixel may represent the signal received at one of the transducer elements. This need not be a one-to-one correspondence. A single transducer element may correspond to more than one pixel and vice-versa. Each image may represent the signals received from one pulse. It should be understood that “one” pulse will usually be transmitted by many different transducer elements. These versions of the “one” pulse might also be transmitted at different times, e.g. the matrix array could be configured to activate a “wave” of transducer elements by activating each line of the array in turn. This collection of transmitted pulses can still be considered to represent “one” pulse, however, as it is the reflections of that pulse that are used to generate a single image of the sample. The same is true of every pulse in a series of pulses used to generate a video stream of images of the sample.

The pulse selection module 303 selects the particular pulse shape to be transmitted. It may comprise a pulse generator, which supplies the transmitter module with an electronic pulse pattern that will be converted into ultrasonic pulses by the transducer. The pulse selection module may have access to a plurality of predefined pulse shapes stored in a memory 314. The pulse selection module may select the pulse shape to be transmitted automatically or based on user input. The shape of the pulse may be selected in dependence on the type of structural feature being imaged, its depth, material type etc. In general the pulse shape should be selected to optimise the information that can be gathered by the signal processor 305 and/or improved by the image enhancement module 310 in order to provide the operator with a quality image of the object.

An example structure of part of the scanning apparatus is illustrated in FIG. 4. The scanning apparatus comprises a transducer element, generally illustrated at 401, comprising a piezoelectric layer 402 with electrically conducting layers 403, 404 to the top and bottom (in the orientation of the figure). The electrically conducting layers provide for electrical connection between the piezoelectric layer and the processor 204. The scanning apparatus comprises a backing layer 406 provided above the transducer element and a coupling layer 408 provided below the transducer element. The coupling layer suitably forms the surface of the scanning apparatus, which can be placed against an object to be imaged. Insulating layers 410 and 412 separate the active layers of the transducer element from the backing layer and the coupling layer, respectively.

In one implementation, one of the conducting layers 403, 404 acts as a transmitter electrode, on which drive signals are applied to drive the piezoelectric layer 402. The other of the conducting layers 403, 404 can act as a receiver electrode, on which electrical signals generated by the piezoelectric layer 402 in response to received ultrasound signals are applied. When transmitting, the conducting layer that is not acting as the transmitter electrode can be used to generate a potential difference across the piezoelectric layer, for example by being held at a ground voltage level. When receiving, the conducting layer that is not acting as the receiver electrode can be held at a given voltage level, for example ground voltage level.

The transmitter structure of the scanning apparatus comprises a plurality of transmitting elements, for example the piezoelectric layer 402, in a stacked configuration in the direction of transmission of the ultrasound signals. That is, the transmitting elements are spatially offset from one another in the direction of transmission of ultrasound towards an object for imaging. The transmitting elements are capable of transmitting ultrasound signals. The receiver structure comprises a plurality of receiving elements. The receiving elements are spatially offset from one another in the same direction as that in which the transmitting elements are offset from each other. The receiving elements are capable of detecting received ultrasound signals. In the orientation of FIG. 4, the sound waves will be transmitted vertically downwards, through the coupling layer towards an object for imaging. In the example illustrated in FIG. 4, the transducer comprises the transmitting element (e.g. the piezoelectric layer 402 and one of the conducting layers 403, 404) and the receiving element (e.g. the piezoelectric layer 402 and the other of the conducting layers 403, 404). The transducer element is repeated n times in the structure, where n>1.

Thus one transmitting element is stacked on top of another transmitting element in the structure shown in FIG. 4. The conducting layer 403, 404 provides an interconnect to the piezoelectric layer for conducting drive signals (for transmission of sound signals) and for conducting electric signals representative of received sound signals. Suitably one of the conducting layers conducts drive signals to the transmitting element and the other of the conducting layers conducts received signals from the receiver element.

Suitably one conducting layer is coupled to a signal driver for driving the piezoelectric material. In some examples, the signal driver can be provided at the transmitter module 302. Suitably the other conducting layer is coupled to the signal processor 305 for processing of the received signals. The other conducting layer may couple to the signal processor via the receiver module 306.

An example of a scanning apparatus comprising a dual layer multilayer structure (where two transducer elements are spatially offset from one another in the ultrasound transmission direction) is illustrated in FIG. 5. The multilayer structure comprises a backing layer 506, an insulating layer in the form of a polyimide layer 510a. A conducting layer in the form of a copper layer 503a is provided to one side of a piezoelectric layer in the form of PVDF 502a. To the other side of the PVDF is another conducting copper layer 504a. The two conducting layers 503a and 504a and the PVDF layer 502a together form a transducer 520. The conducting layers couple to the processor via signal lines 522 and 524.

To the other side of the copper layer 504a from the PVDF layer 502a is an insulating polyimide layer 510b, followed by a repetition of a copper layer 503b, a PVDF layer 502b and another copper layer 504b. The two conducting layers 503b and 504b and the PVDF layer 502b together form another transducer 530. The conducting layers couple to the processor via signal lines 532 and 534.

A further polyimide layer 512 separates the transducer 530 from a coupling layer 508.

The insulating layer may be bonded to the conducting layer in any suitable manner. For example, the insulating layer may be bonded to the conducting layer by a suitable adhesive. The surface of the insulating layer may be etched prior to bonding with the conducting layer to increase the strength of the bonding.

The insulating layer may be provided with a metallic coating to improve the bonding between the insulating layer and the conducting layer. In some examples the conducting layer comprises copper. In some examples the metallic coating comprises gold or nickel.

The coupling layer may comprise a dry coupling, for example an elastomer.

The coupling layer may comprise a hard coupling. The coupling may comprise a polymer such as a thermoplastic polymer. The coupling may comprise a cross-linked polymer. The coupling may comprise polyetherimide. The coupling may comprise polyether ether ketone (PEEK). The coupling may comprise a cross-linked polystyrene such as Rexolite.

Different materials will have different properties. For example, one coupling material may have differing frequency transmission characteristics compared to another coupling material. The coupling material may be selected in dependence on the desired characteristics of the scanning apparatus. For example, where offset, for example, stacked, transmitting elements are used, which can help to reduce the lower frequency bound of the transmission spectrum (or at least increase the energy contained within the lower frequency range), it is likely to be desirable to select a coupling that efficiently passes such lower frequencies.

In some examples, the coupling can comprise a material that filters out selected frequencies. For example, the coupling may comprise a material that filters out higher frequencies. Such filtering of higher frequencies may be useful where the scanning apparatus is configured to increase the energy towards lower frequencies. In this case, the processor need only process signals at the lower frequencies, the higher frequencies being attenuated or filtered by the coupling. This can simplify and/or increase the accuracy of the signal processing.

In some examples the scanning apparatus comprises a seal for sealing between a coupling and the transducer. A seal, such as a rubber seal, can be provided around the edge of the transducer, allowing couplings to be quickly and easily replaced, whilst keeping the transducer module watertight.

The stacked transmitting elements can couple to standard driving electronics. For example, a 2D matrix array of transmitting elements might comprise 128×128 elements. In some examples, the 2D array can be formed by the intersections of a first set of 128 conducting lines with a second set of 128 conducting lines. Each of the first set of conducting lines, and each of the second set of conducting lines can be coupled to a signal driver configured to drive signals on the lines so as to cause the transmitting elements to generate ultrasound signals as desired.

Where, as in embodiments of the present techniques, the scanning apparatus comprises stacked (or multilayer) transmitting elements, or stacked (or multilayer) transducer elements, these stacked elements can be thought of as forming a 3D array.

In an example, where the transducer of the scanning apparatus comprises the same 128×128 connecting lines as in the example above, and the multilayer comprises two such elements stacked one on top of the other, the array can comprise 64×64 laterally spaced elements. In another example, where the transducer of the scanning apparatus comprises the same 128×128 connecting lines as in the example above, and the multilayer comprises four such elements stacked one on top of the other, the array can comprise 32×32 laterally spaced elements.

In these examples, the 64×64 elements and the 32×32 elements can be driven by the same electrical interconnects (e.g. the conducting layers) as the 128×128 array of elements. The multilayer transducer structure can therefore be easily incorporated into existing electrical control systems if desired. This is because there may be the same number and physical configuration of electrical interconnects to the layers of piezoelectric material in the 3D arrays (dual and quad layers, as in the examples above) as in a single layer (2D) array.

In other examples, fewer electrical connections of a set of 128×128 electrical connections can be used.

Differences in the electronics and/or the driving signals can be used to take account of the multilayer structure of the transducer.

For example, it can be advantageous to transmit ultrasound pulses from a transmitting element in one layer of the array at a different time compared to transmitting ultrasound pulses from a transmitting element in another layer of the array. This is so that the interference of the pulses from the transmitting elements at the different layers of the array can be modified to achieve a desired overall pulse shape transmitted from the scanning apparatus for coupling into the object to be imaged.

In some examples, the scanning apparatus comprises delay circuitry configured to delay the transmission of an ultrasound signal. The delay circuitry can be configured to delay a trigger signal configured to cause a transmitter to transmit an ultrasound signal.

Suitably, the scanning apparatus is configured to delay the transmission of an ultrasound signal from a layer of piezoelectric material closer to the front of the transducer compared to the transmission of an ultrasound signal from a layer of piezoelectric material further from the front of the transducer.

Suitably, the scanning apparatus is configured to delay the transmission of an ultrasound signal from a transmitting element closer to the front of the transducer compared to the transmission of an ultrasound signal from a transmitting element further from the front of the transducer.

The front of the transducer is the side of the transducer configured to face towards the object to be imaged. Thus, transmission of an ultrasound signal or pulse can be delayed in respect of a transducer element, or a transmitting element, further along the direction of propagation of the ultrasound signal.

Where more than two layers are provided in the multilayer transducer, the delay circuitry can be configured to sequentially delay the transmission of ultrasound signals through the stack, with the delay increasing towards the front of the transducer. Thus, the delay circuitry can be configured to control the delay in dependence on the amount by which a transmitting element is offset from another transmitting element.

Suitably the delay introduced by the delay circuitry is predetermined. Suitably the delay introduced by the delay circuitry is dependent on the acoustic properties of the transducer.

The delaying of signal transmission enables control of the interference of the signals along the transmission path. For example, the delay can be configured so that the signals constructively interfere as they leave the transducer or couple into the object to be imaged. This approach can increase the energy and/or enable control of the energy spectrum of the signal output from the transducer.

The scanning apparatus suitably comprises receiver delay circuitry configured to delay a signal representative of a received ultrasound signal. The delay circuitry may comprise the receiver delay circuitry. The delay circuitry and/or the receiver delay circuitry can be provided as part of a signal processor, such as a digital signal processor. A signal received at one layer of a multilayer structure can be delayed relative to a signal received at another layer of the multilayer structure, the layers being offset from one another in the direction of propagation of the reflected pulse. The amount of delay can be selected in dependence on one or more of the offset between the layers, the acoustic properties of the transducer, and the ultrasound frequency.

The delaying of received signals enables control of the interference of the received signals. For example, the delay can be configured so that the signals constructively interfere. This approach can increase the energy of the received signal.

This is figuratively illustrated in FIG. 6, which shows a multilayer structure comprising two transducer elements stacked one on top of the other. The transducer element 602 furthest from the front of the scanning apparatus (defined by the coupling layer 604) is controlled to transmit a pulse at a first time t₁. The transducer element 606 closest to the front of the scanning apparatus is controlled to transmit a pulse at a second time t₂ which is later than the first time. That is, a delay of (t₂−t₁) has been introduced between the transmission of the pulses by the transducer elements 602, 606. The delay suitably corresponds to the time taken for the pulse from transducer 602 to reach transducer 606. Thus, the two pulses will constructively interfere with one another, increasing the energy output from the scanning apparatus. Note that the delay as illustrated has been greatly exaggerated for illustrative purposes. In a practical implementation of a dual layer multilayer structure, a typical delay is likely to be in the order of 10 to 1000 ns, for example 50 to 500 ns. The actual delay will depend on the speed of propagation of the sound wave through the structure, which is a function of the material characteristics (such as elasticity and density) of the structure itself.

In some examples, each layer of transmitting elements can couple to a respective signal driver. Thus, one or more signal driver can be used to drive signals to a plurality of layers of the multilayer transducer, or each signal driver can be configured to drive signals to a single layer of the multilayer structure. Thus, in examples described herein in which two layers of transmitting elements are provided, there may be two signal drivers, each coupled to a respective one of the two layers. In other examples, where four layers of transmitting elements are provided, there may be four signal drivers, each coupled to a respective one of the four layers. It will be understood that these numbers of layers are examples only, and that other numbers of layers of the multilayer structure may be provided.

Where a signal driver is coupled to a plurality of layers of the multilayer transducer, a multiplexer and/or demultiplexer may be provided to multiplex trigger signals to be sent to the transmitting elements, and to demultiplex signals received from the receiving elements.

A demultiplexer may take a finite time to clear out data relating to one pulse before it is able to process data relating to a further pulse. In some cases this can take approximately 1 μs. To avoid such a delay, it can be preferable to provide separate signal drivers for each layer of the multilayer structure. For example, separate transmitter chips may be provided for each layer of the multilayer structure.

As the number of layers in the multilayer structure is increased, whilst keeping the number of connecting lines constant, the resolution of the system will decrease. For example, where there are 128×128 connecting lines, a dual layer transducer structure will have 64×64 elements, rather than the 128×128 elements of the single layer structure. A quad layer transducer structure will have 32×32 elements. This is schematically illustrated in FIGS. 7 to 9.

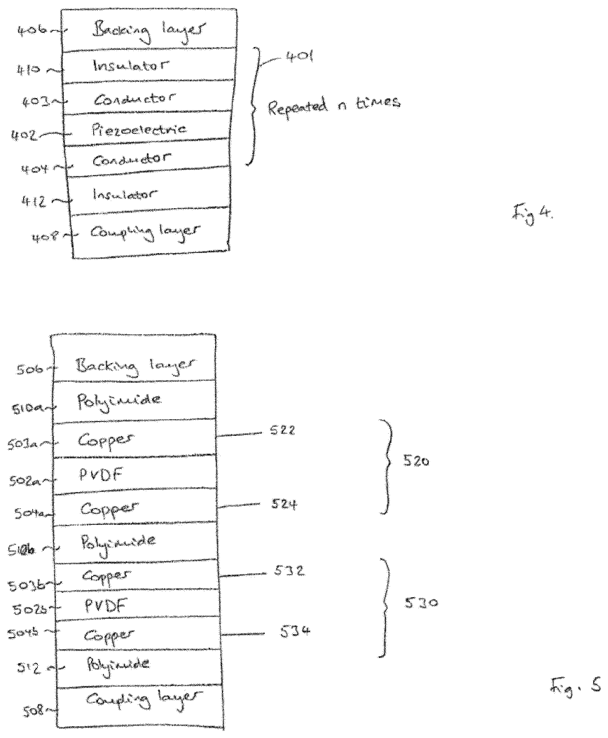

FIG. 7 shows a 12×12 array of electrodes, forming transducer elements at the intersections of the horizontal electrodes with the vertical electrodes. A transducer element 701 is circled. An example of forming the matrix array of FIG. 7 into a dual layer multilayer structure is shown in FIG. 8. FIG. 8 shows a 6×6 array of electrodes. Note that the lines of electrodes illustrated as pairs may in at least some embodiments be placed one on top of the other. Since FIG. 8 shows a plan view of the electrode layout, the electrodes have been slightly separated for clarity in the illustration. A transducer element 801 is circled. It will be seen that this corresponds to four transducer elements of FIG. 7. The spacing of the transducer elements of FIG. 8 is greater than that of FIG. 7.

An example of forming the matrix array of FIG. 7 into a quad layer multilayer structure is shown in FIG. 9. FIG. 9 shows a 3×3 array of electrodes. Note that the lines of electrodes illustrated as groups of four may in at least some embodiments be placed one on top of the other. Since FIG. 9 shows a plan view of the electrode layout, the electrodes have been slightly separated for clarity in the illustration. A transducer element 901 is circled. It will be seen that this corresponds to sixteen transducer elements of FIG. 7. The spacing of the transducer elements of FIG. 9 is greater than that of FIG. 7 and of FIG. 8.

In some examples, the spacing of transducer elements can be the same in the 64×64 array as in the 128×128 array, and the same in the 32×32 array as in the 128×128 array, and the overall area of the array can be reduced accordingly (this assumes that the total number of electrodes is not changed). In other examples, transducer element spacing can be balanced with array area, as desired.

The delay in pulse transmission may be of the order of 20 ns, of the order of 10 ns, of the order of 5 ns, of the order of 2 ns, and so on. Preferably the delay provides a resolution of 5 ns or less between pulses transmitted from each layer, or from successive layers in the structure.

It is desirable to generate an ultrasound pulse with a high amplitude at a low frequency. For example, it is desirable to generate an ultrasound pulse with as high an amplitude as possible at a low frequency. A low frequency may be one that is less than 2 MHz, less than 1 MHz, approximately 0.5 MHz or less than 0.5 MHz. The multilayer transducer structure described herein can enable enhancements to focussing of an ultrasound transducer module. The multilayer transducer structure described herein can enable enhancements to sensitivity of an ultrasound transducer module. The multilayer transducer structure can permit an increase in the sensitivity of the pulse transmitted by the transducer module and/or can permit an increase in the power of a transmitted pulse, in a given frequency range or frequency ranges, and hence a corresponding increase in the resulting reflection of that transmitted pulse.

The energy contained in an ultrasound pulse increases with the area of a transducer element used to generate the pulse. The energy increases linearly with area. Hence using a larger electrode will increase the energy of a pulse generated using that electrode. Using a stacked electrode structure will effectively increase the area of the transducer elements used to generate a pulse. Using a stacked electrode structure will increase the energy of a pulse generated using that stacked electrode structure. For example, where four layers are used, there may be fewer conducting lines, or electrodes, in each layer. In examples described herein, the number of conducting lines per layer can decrease from 128 in a single layer structure to 32 in a four layer structure. The conducting lines may be wider in the multiple layer structure. For example, the conducting lines may be four times wider. Where such wider conducting lines are used in both the transmit and receive flex circuits, the area of the transducer elements will increase by sixteen times. Thus, the energy of the transmitted pulse will increase by a factor of sixteen.

Further, in a multilayer structure, the conducting lines are stacked on one another, leading to an increase in effective area of the transducer elements contributing to each pulse.

As the width of electrodes increases, the area of the electrodes increases. This increases the amount of energy generated by each layer. By doubling the width of an electrode, the area (or energy) increases by 4 times (i.e. 2×2). If an electrode is 4 times wider, the area (or energy) increases by 16 times (i.e. 4×4).

For additional layers, there is also an increase in energy due to the delay between layers and constructive interference between the transmitted pulses. A further increase in energy occurs due to a ‘delay-and-add’ when receiving reflected pulses. For two layers, there will be a doubling of energy due to transmit delay and a further doubling of energy due to delay-and-add when receiving. For four layers, there will be a quadrupling of energy due to transmit delay and a further quadrupling of energy due to delay-and-add when receiving.

Thus, a dual layer structure can provide: 4 times the area, 2 times transmit energy and 2 times receive energy, i.e. 4×2×2=16 times more energy. A quad layer structure can provide: 16 times the area, 4 times transmit energy and 4 times receive energy, i.e. 16×4×4=256 times more energy. Note that these multiples of energy do not take attenuation for each layer into consideration, so the increase in energy is likely to be slightly less than these figures in practice.

The benefit of the present techniques is that, despite the reduction in resolution, the multilayer transducer structure can enable transmission of energy spectra that are not able to be obtained using a single layer structure of the same materials. In many situations the modified energy spectrum of a transmitted ultrasound pulse offered by the multilayer transducer structure can reveal additional information about the object being imaged, compared to using a single-layer transducer, for example by comprising a greater proportion of energy at lower frequencies.

In some examples, the lower bound of the energy range in which useful energy can be transmitted by the scanning apparatus can be reduced to 1 MHz. In some examples the lower bound can be reduced to 0.5 MHz. The particular layer of piezoelectric material may not ordinarily be able to transmit energy at such low frequencies, where a single transducer element is provided (comprising, for example, a single layer of piezoelectric material). The scanning apparatus is suitably able to transmit at such low frequencies by virtue of the offset or stacked arrangement of the transmitting elements.

Resolution of the scans obtained using the multilayer transducer can be increased in other ways. For example, resolution can be increased by the processor. Resolution can be increased by providing additional electrodes. Thus, it is possible to realise a dual layer 128×128 matrix array, or a quad layer 128×128 matrix array, and so on, where the number of electrodes is increased accordingly.

It is not necessary to provide both the insulator layers 410, 412. In some implementations, neither of the insulator layers 410, 412 need be provided. For example, it is possible to sputter electrodes (i.e. the conducting layer) directly onto the piezoelectric layer. In this case, the corresponding insulating layer need not be provided. Where electrodes are sputtered onto both sides of the piezoelectric layer 402, forming both conductor layers 403, 404, the insulating layers 410, 412 need not be provided.

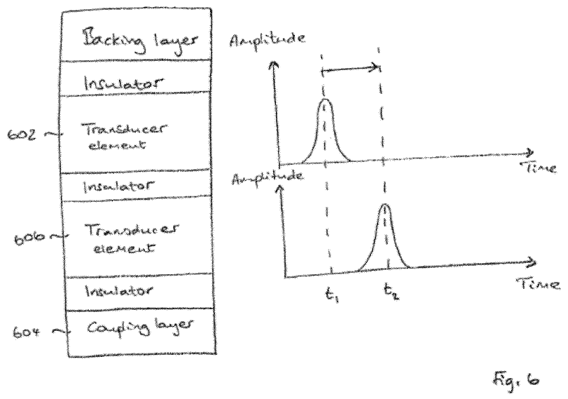

A description will now be given of electrodes for use in an ultrasound transducer module, and arrangements of such electrodes. A typical transducer module 1002 is shown in FIG. 10. The transducer module comprises a transducer 1004 which comprises the transmitting and receiving electrodes (or conducting lines) and the piezoelectric material. The transducer module comprises a body 1006 disposed above the transducer (in the orientation of FIG. 10) The body is located on an opposite side of the transducer from the scanning surface of the transducer that is placed against a sample during a scan. The body comprises electrical connections to drive the transducer. The body can also comprise two or more circuits. Each circuit is suitably configured to couple to a transmitter or receiver electrode. A circuit coupled to a transmitter electrode is suitably configured to drive the transmission of ultrasound pulses via the transmitter electrode. Such a circuit can comprise or be part of a signal driver. Such a circuit may form part of a transmitter module. A circuit coupled to a receiver electrode is suitably configured to capture signals received from the receiver electrode. Such a circuit can comprise or be part of a receiver module. The body can comprise a heat sink to assist in cooling the transducer and/or the circuits. An end of the heat sink distal from the transducer may comprise cooling elements to cool the heat sink. The cooling elements may comprise cooling fins for dissipating heat to the atmosphere.

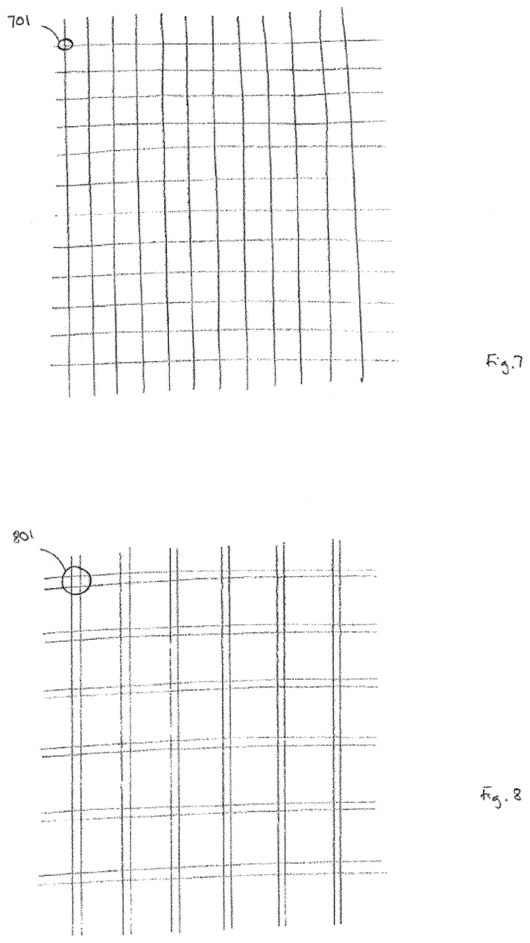

FIG. 11a shows a plan view of a transducer module, in which selected elements are shown in an exploded view. Not all elements of the transducer module are illustrated in this figure for clarity. A heat sink 1102 is provided. The heat sink is suitably located within the body 1006. The heat sink may be provided centrally within the body. Around the heat sink are provided a plurality of circuits 1104, 1106. In the illustrated example, a single transducer layer is provided. Two circuits are provided. One circuit can be used to drive the transmitter electrode. The other circuit can be used to capture signals received at the receiver electrode. The circuits may be coupled together with an electrical connection 1108. The electrical connection may be any suitable cable, such as a flexible cable. The coupling of the circuits together enables a single connection to be made to a control device for controlling the transmission of ultrasound pulses and for capturing received signals. For example, a single connection can facilitate coupling to both the transmitter module and receiver module. Alternatively, separate connections can be made between the control device and each circuit.

The transmitting electrodes are provided at an angle to the receiving electrodes. Suitably the transmitting electrodes will be at right angles to the receiving electrodes. For ease of connection to the relevant electrodes, the circuits illustrated in FIG. 11a are also at right angles to one another. This enables the connection to be made in a simple manner to the electrodes, which can then bend through 90 degrees to form the transducer. Suitably, the electrodes are provided on a flex circuit. The transmitter electrodes are provided on a transmitter flex circuit and the receiver electrodes are provided on a receiver flex circuit. It will be understood that the transmitter and receiver flex circuits may have the same layout. The relevant flex circuit will transmit or receive based on the electrical coupling to the control device.

FIG. 11b illustrates a side view of the transducer module of FIG. 11a. The left hand side of this figure represents a view along the x-axis of FIG. 11a from the centre outwards and the right hand side represents a view along the y-axis of FIG. 11a from the centre outwards. Circuit 1104 comprises a connector 1110 for coupling the circuits to the control device. Circuit 1104 comprises a further connector 1112 for coupling to one of a transmitter flex circuit and a receiver flex circuit. Circuit 1106 comprises a connector 1114 for coupling to the other of the transmitter flex circuit and the receiver flex circuit. The transducer is illustrated at 1116. The transducer comprises a pair of flex circuits 1118, 1120, one to either side of a piezoelectric layer 1122.

Suitably the connectors 1110, 1112, 1114 are located on the side of the circuits facing away from the heat sink. This enables the circuits to be provided closer to the heat sink to improve thermal contact with the heat sink. The transducer module may also comprise thermal paste or gel, provided between the heat sink and one or more of the circuits. The thermal paste can further improve thermal contact between at least one of the circuits and the heat sink.

FIG. 12 shows two circuits face on. The connectors 1110, 1112, 1114 are provided along the width of the circuits. This need not be the case. In some cases, one or more connector can be of a different width to a circuit. For example, one or more connector can be smaller than a respective circuit. Suitably the connector is sized to receive a corresponding connector on a flex circuit.

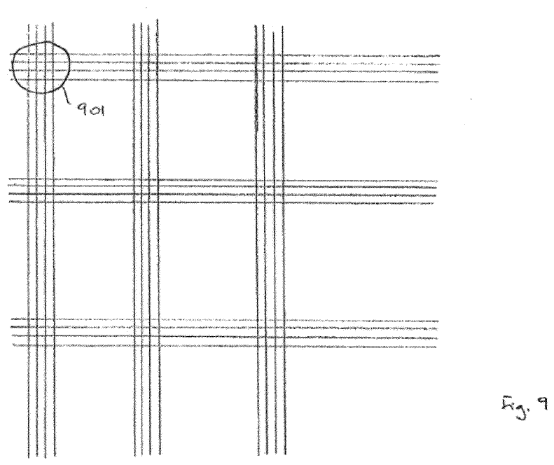

As discussed elsewhere herein, the transducer can comprise an array of transducer elements. There may be 128 elements along each side of the array. Thus, there may be 128 separate electrodes in both the transmitting and receiving flex circuits. To couple independently to each of these 128 electrodes, separate electrical connections are provided on the flex circuit connectors. FIG. 13 illustrates different arrangements of electrical connections or pads 1302 on the flex circuit connectors. FIG. 13a shows pads arranged in a linear row. The pad width is typically greater than the electrode 1304 width (and hence the transducer element width, since the transducer element is formed where a transmitting electrode crosses a receiving electrode). The pads in the flex circuit connectors may be provided at a pitch of 300 μm. The electrodes may be provided at a pitch of 500 μm. A more compact arrangement is shown in FIG. 13b, in which the pads are staggered. Staggering the pads in this way enables the electrodes to be located closer to one another. Thus, a relatively greater number of electrodes can be provided in a flex circuit connector of a given width.

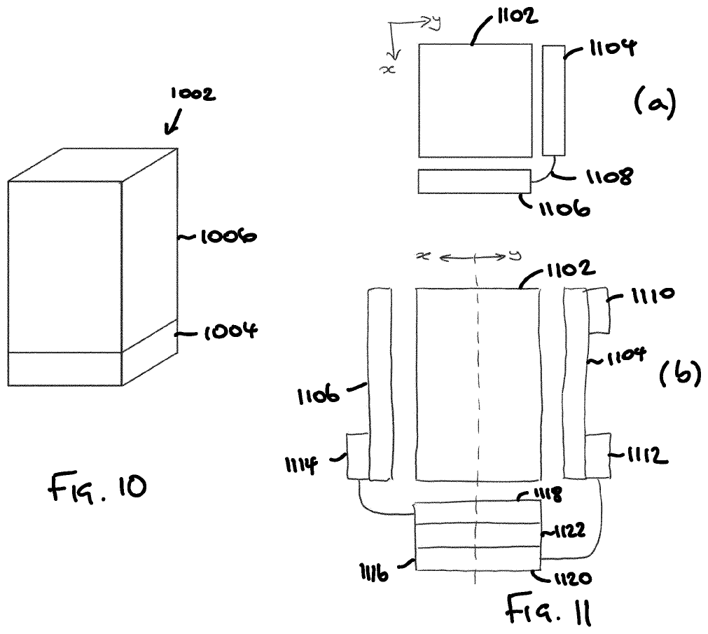

The spacing of the electrodes in the flex circuit connector need not be the same as the spacing of the electrodes in the transducer. FIG. 14a illustrates a typical flex circuit. A flex circuit connector is illustrated at 1402. A transition region 1404 is located between the flex circuit connector and the part of the flex circuit forming the transducer 1406. As illustrated, electrodes across the width of the transducer portion of the flex circuit have a greater pitch than corresponding electrodes across the width of the flex circuit connector. FIG. 14b illustrates the flex circuit of FIG. 14a rotated by 90 degrees. FIG. 14c illustrates the two flex circuits of FIGS. 14a and 14b, one on top of the other. Transducer elements are formed where the electrodes from one flex circuit cross those of the other flex circuit. Whilst FIG. 14 shows electrodes of the flex circuits, only a small number are illustrated for clarity. Different flex circuits can comprise different numbers of electrodes. A typical flex circuit for use in a single layer transducer will comprise 128 electrodes. Thus two such flex circuits will form a transducer array with 128×128 transducer elements.

The above example describes all the desired electrodes as being part of the same flex circuit. This is not necessarily the case. In an alternative, complementary flex circuits may be provided which each comprise a portion of the number of desired electrodes. Where the transducer array is to comprise 128×128 transducer elements, a flex circuit may comprise 64 electrodes. In this case, additional flex circuits are provided. For example, where each flex circuit comprises 64 electrodes, the transmitting electrodes can be formed from two flex circuits and the receiving electrodes can be formed from two flex circuits.

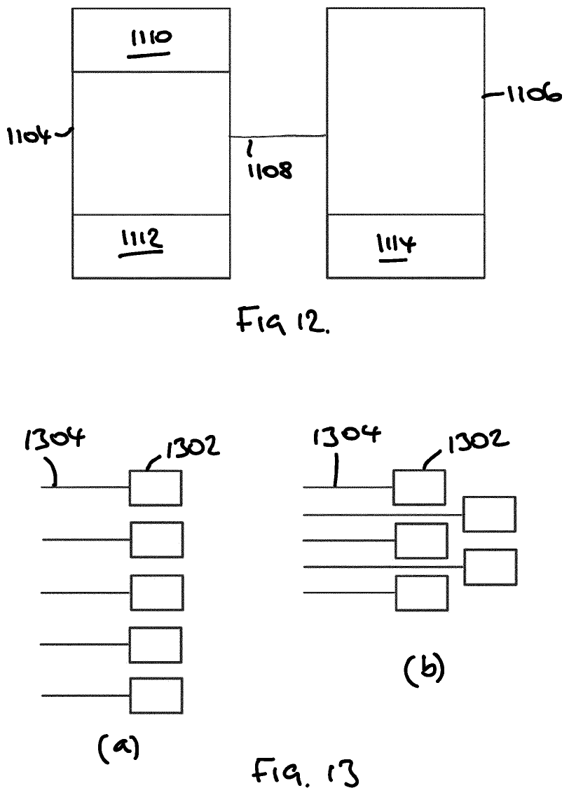

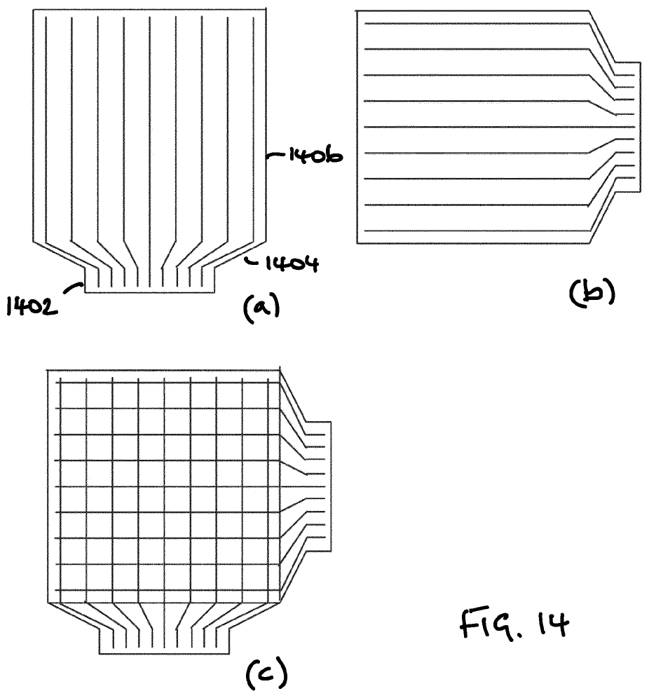

Reference is now made to FIGS. 15 and 16. FIG. 15 illustrates four flex circuits which can form a single transducer layer. The receiver electrodes of the transducer layer can be formed from the two flex circuits shown in FIGS. 15a and 15d, and the transmitter electrodes of the transducer layer can be formed from the two flex circuits shown in FIGS. 15b and 15c. The receiver electrodes are all parallel with one another. The transmitter electrodes are all parallel with one another. Suitably, when the flex circuits are overlaid, the receiver electrodes in one receiver flex circuit will not lie directly above the receiver electrodes in the other receiver flex circuit. Similarly, the transmitter electrodes in one transmitter flex circuit will not lie directly above the transmitter electrodes in the other transmitter flex circuit.

FIG. 16 illustrated how the electrodes in the two receiver flex circuits or the two transmitter flex circuits may be located relative to one another. Suitably the electrodes from one receiver (or transmitter) flex circuit alternate with the electrodes from the other receiver (or transmitter) flex circuit. The pitch between adjacent electrodes may be constant across the transducer layer. Suitably the pitch between the electrodes in one receiver (or transmitter) flex circuit is the same as the pitch between the electrodes in the other receiver (or transmitter) flex circuit.

This can be achieved in any suitable manner. One way of providing alternating electrodes is to couple up electrodes via the pads to even-numbered connections in the circuit connector for one of the pair of flex circuits and to odd-numbered connections for the other of the pair of flex circuits. For example, where a circuit connector comprises 128 connections, the flex circuit connector of one of a pair of flex circuits can couple to numbers 1, 3, 5, . . . , 125, 127 of the connections. The flex circuit connector of the other of the pair of flex circuits can couple to numbers 2, 4, 6, . . . 126, 128 of the connections.

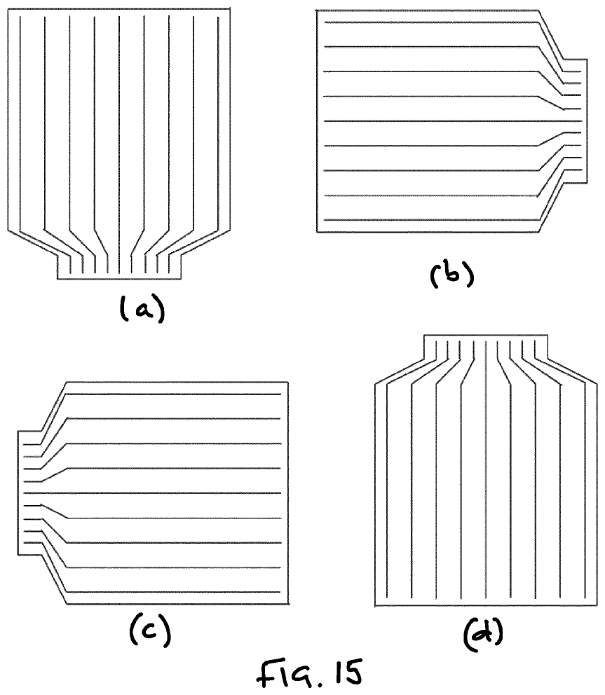

FIG. 17 shows an exploded plan view of elements of a transducer module. The body of the transducer module 1702 is located in between four circuits 1704, 1706, 1708, 1710. The circuits are coupled together in series by couplings 1705, 1707, 1709. The couplings are suitably flexible. Each flex circuit can couple to a respective circuit. For example, a pair of flex circuits can form a receiver flex circuit. Each flex circuit of this receiver pair can couple to opposite ones of the circuits, such as circuits 1704 and 1708. A further pair of flex circuits can form a transmitter flex circuit. Each flex circuit of this transmitter pair can couple to opposite ones of the circuits, such as circuits 1706 and 1710.

FIG. 18 shows four circuits 1802, 1804, 1806, 1808 face on. Each circuit is provided with a connector 1810, 1812, 1814, 1816 for coupling to a flex circuit. The circuits are coupled to one another in series by couplings 1803, 1805, 1807. The couplings are suitably flexible. Circuit 1802 comprises a further connector 1818 for coupling the circuits to a control device. The connectors can be provided on the side of the circuits facing away from the heat sink, to facilitate better thermal contact between the circuits and the heat sink. Thermal paste or gel may be provided between one or more circuit and the heat sink to further improve thermal contact therebetween.

Flex circuits for use in a two-layer transducer structure will now be described. As described above, where 128 connections are available for transmitting and 128 connections are available for receiving, it is convenient to use 64 of those connections for transmitting on each layer and 64 of those connections for receiving on each layer. Thus, four flex circuits may be provided, each of which can comprise 64 electrodes. Each such flex circuit can comprise 64 pads on the flex circuit connector.

The four flex circuits of such a two-layer transducer structure may take a similar form to the flex circuits described with reference to FIG. 15. Suitably, electrodes of the transmitter flex circuit of one layer are disposed in line with the electrodes of the transmitter flex circuit of the other layer, in the direction of transmission of ultrasound towards an object for imaging. Conveniently, the transducer module is configured to emit the ultrasound pulse in a direction normal to the surface of the transducer. Thus, suitably electrodes of one transmitter flex circuit are above corresponding electrodes of the other transmitter flex circuit, in the orientation of the transducer module of FIG. 10.

Suitably, electrodes of the receiver flex circuit of one layer are disposed in line with the electrodes of the receiver flex circuit of the other layer, in the direction of transmission of ultrasound towards an object for imaging (and hence the direction in which a pulse echo can be received). Conveniently, the transducer module is configured to emit the ultrasound pulse in a direction normal to the surface of the transducer, and can be configured to receive a reflected pulse in a direction normal to the surface of the transducer. Thus, suitably electrodes of one receiver flex circuit are above corresponding electrodes of the other receiver flex circuit, in the orientation of the transducer module of FIG. 10.

Flex circuits for use in a four-layer transducer structure will now be described. As described above, where 128 connections are available for transmitting a pulse and 128 connections are available for receiving a pulse echo, it is convenient to use 32 of those connections for transmitting on each layer and 32 of those connections for receiving on each layer. Thus, eight flex circuits may be provided, each of which can comprise 32 electrodes. Each such flex circuit can comprise 32 pads on the flex circuit connector.

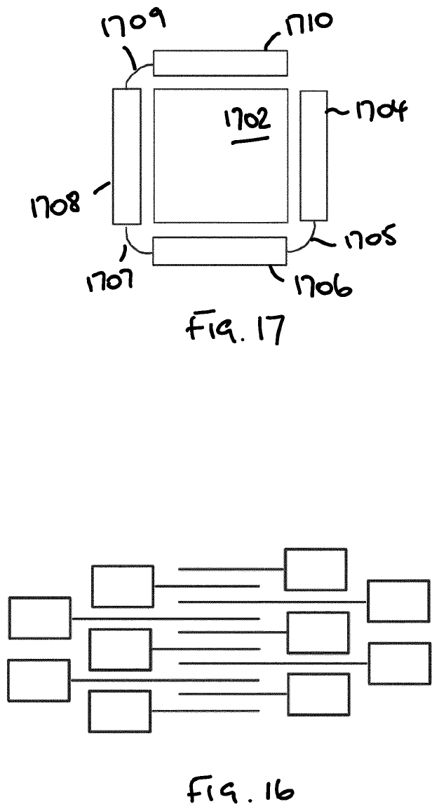

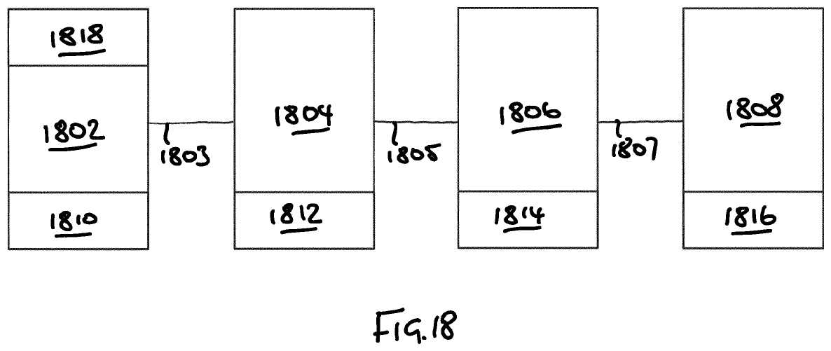

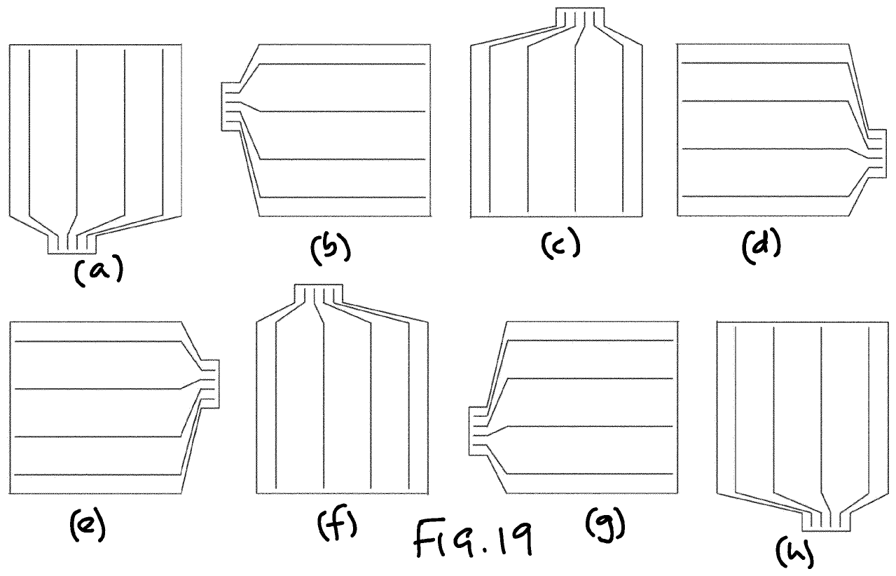

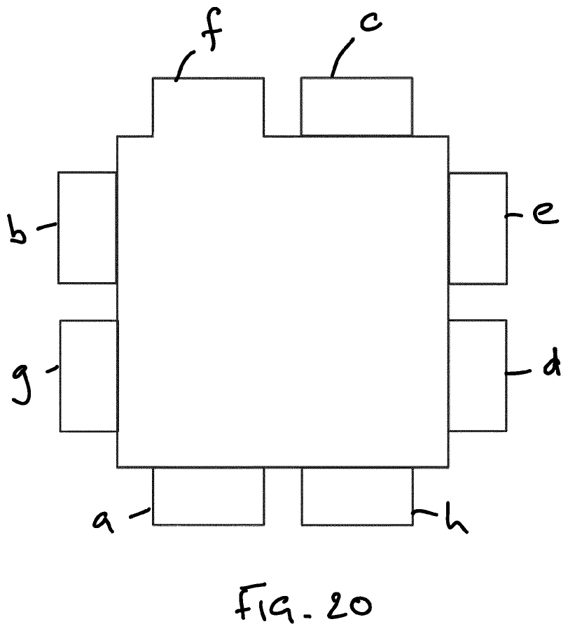

The eight flex circuits of such a four-layer transducer structure may take the form as illustrated in FIG. 19. The flex circuits are schematically shown in this figure as comprising four electrodes, to illustrate how the electrodes in the transducer region of each flex circuit can be coupled to the flex circuit connector. As illustrated, the flex circuit connector is provided towards a corner of the flex circuit, rather than being provided centrally along one edge. This is so that each flex circuit connector can be provided separately around the transducer when the eight flex circuits are overlaid. This facilitates an easier connection between the flex circuits and the circuit connectors. An illustration of eight such flex circuits being overlaid is provided in FIG. 20.

Suitably, electrodes of the transmitter flex circuit of one layer are disposed in line with the electrodes of the transmitter flex circuits of the other layers, in the direction of transmission of ultrasound towards an object for imaging. Conveniently, the transducer module is configured to emit the ultrasound pulse in a direction normal to the surface of the transducer. Thus, suitably electrodes of one transmitter flex circuit are above or below corresponding electrodes of the other transmitter flex circuits, in the orientation of the transducer module of FIG. 10.

Suitably, electrodes of the receiver flex circuit of one layer are disposed in line with the electrodes of the receiver flex circuits of the other layers, in the direction of transmission of ultrasound towards an object for imaging (and hence the direction in which a pulse echo can be received). Conveniently, the transducer module is configured to emit the ultrasound pulse in a direction normal to the surface of the transducer, and can be configured to receive a reflected pulse in a direction normal to the surface of the transducer. Thus, suitably electrodes of one receiver flex circuit are above or below corresponding electrodes of the other receiver flex circuits, in the orientation of the transducer module of FIG. 10.

Each layer of the transducer structure will comprise a receiver flex circuit and a transmitter flex circuit, with a piezoelectric material disposed therebetween. Insulation layers will also be provided as explained elsewhere herein.

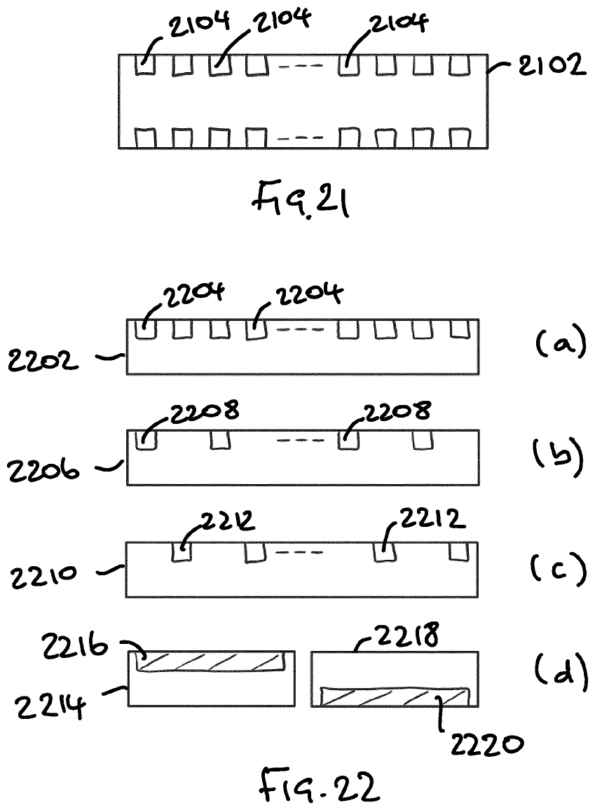

With reference to FIGS. 21 and 22, a description will now be provided of the circuit connectors and the flex circuit connectors. A circuit connector, such as circuit connector 1112, is illustrated in FIG. 21 at 2102. The circuit connector 2102 is shown in plan view. The circuit connector comprises two rows of connections 2104. Each row of connections can comprise 64 connections, to make a total of 128 connections. Such a connector can be used for coupling with 128 electrodes in a flex circuit. A corresponding flex circuit connector can comprise two rows of 64 connections, each row being on an opposite face of a connection portion for engaging with the connections of the circuit connector 2102.

Alternatively, the circuit connector 2102 can comprise two rows of 128 connections. Such a configuration can be useful when coupling to a flex circuit connector with 128 connections which are all disposed on the same face of the flex circuit connector. An example of such a flex circuit connector is illustrated in FIG. 22a at 2202. The connections 2204 are disposed in this example on the upper face. In this case, the flex circuit connector 2202 can be coupled with the circuit connector 2102 either way round whilst still permitting the 128 flex circuit connections to couple with the 128 circuit connector 2104 connections. This arrangement can improve the flexibility of the system.

In an example described above, four flex circuits form a single transducer layer. The electrodes of one receiver flex circuit couple to connectors 1, 3, 5, . . . , 125, 127 of the circuit connector 2102. The electrodes of the other receiver flex circuit couple to connectors 2, 4, 6, . . . , 126, 128 of the circuit connector 2102. Examples of flex circuit connectors suitable for use on such flex circuits are illustrated in FIGS. 22b and 22c. As shown schematically in these figures, pads 2208 on flex circuit connector 2206 couple to (e.g.) odd-numbered connections of the circuit connector 2102 and pads 2212 on flex circuit connector 2210 couple to (e.g.) even-numbered connections of the circuit connector 2102. Again, in these examples, all the pads on the flex circuit connectors 2206, 2210 are provided on one face of the connector. Thus, the flex circuit connectors can be used either way round in the circuit connector 2102. FIGS. 22b and 22c show only the odd- or even-numbered pads, respectively. The flex circuit connectors may comprise only those pads for use in connecting with the circuit connectors, i.e. the odd- or even-numbered pads in the above example. In an alternative, the flex circuit connectors comprise the same number and arrangement of pads, for example a row of 64 or 128 pads, and the remainder of the pads are simply not used, or not connected. This can enable the same type of flex circuit connector to be used in multiple flex circuits. This can help reduce manufacturing costs.

Where four flex circuits form two layers, as described above, the same connection arrangement may be used, albeit with different control over the signals passed to the various electrodes and received from the various electrodes. This ability to use the same physical connections enables a greater flexibility of the system.

Where eight flex circuits form four layers, as described above, the flex circuit connectors can be configured such that two such flex circuit connectors couple to each of four circuit connectors. The flex circuit connectors in this example will comprise 32 pads. These 32 pads suitably couple to 32 connections in either the first 64 connections of a 128-connection connector, or the last 64 connections of a 128-connection connector. The 32 pads of a flex circuit connector may, for example, couple to connections 1-32, connections 33-64, connections 1, 3, 5, . . . , 61, 63, connections 2, 4, 6, . . . , 62, 64, and so on. Similarly, the 32 pads of another flex circuit connector may, for example, couple to connections 65-96, connections 97-128, connections 65, 67, 69, . . . , 125, 127, connections 66, 68, 70, . . . , 126, 128, and so on.

Suitably the two flex circuit connectors that couple to a single circuit connector 2102 are configured so that one of the flex circuit connectors comprises connections on an opposite face compared to the other of the flex circuit connectors. An example of this is illustrated in FIG. 22d. As illustrated a first flex circuit connector 2214 comprises connections 2216 on an upper face, and a second flex circuit connector 2218 comprises connections 2220 on a lower face. This arrangement can facilitate simple coupling between the flex circuit connectors and the circuit connectors.

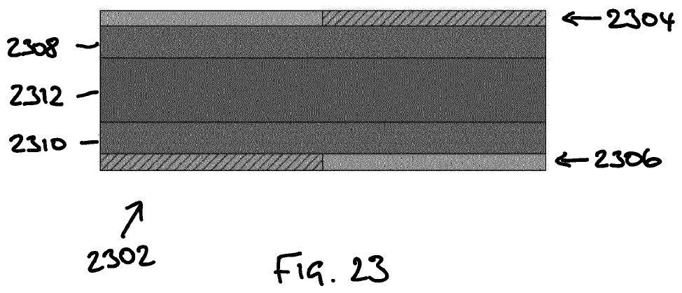

In the arrangement of FIG. 22, the two flex circuit connectors are each provided with a width that is approximately half the width of the circuit connector with which they engage. In this way, both flex circuit connectors can engage simultaneously with the circuit connector. Another arrangement is illustrated in FIG. 23. In this alternative arrangement, each flex circuit connector can have a width approximately the same as the circuit connector (the width of the flex circuit connector may be slightly smaller than the width of the circuit connector, where the flex circuit connector is configured to be inserted within the circuit connector). The thickness of the flex circuit connector is approximately half the thickness of the circuit connector, or less than half the thickness of the circuit connector. Thus, in this arrangement, rather than the flex circuit connectors being inserted into the circuit connector side-by-side, they can be inserted above and below one another.

Suitably, in at least some examples, the flex circuits can be the same as other flex circuits in those examples. For instance, where a single layer transducer structure is formed from two flex circuits (as illustrated in FIG. 14), both flex circuits can be identical to one another. This can simplify the manufacture and/or assembly process.

Where a single layer transducer structure is formed from four flex circuits (as illustrated in FIG. 15), at least two, and preferably all four, flex circuits can be identical to one another. The flex circuits can be rotated and flipped over as appropriate to obtain the different orientations for use in the structure. In some examples, a first and a second of the four flex circuits can be the same as one another, and a third and a fourth of the four flex circuits can be the same as one another. This can simplify the manufacture and/or assembly process.

Where a two-layer transducer structure is formed from four flex circuits, a plurality and preferably all four flex circuits can be identical to one another. The flex circuits can be rotated and flipped over as appropriate in forming the transducer module. This can simplify the manufacture and/or assembly process.

Where a four-layer transducer structure is formed from eight flex circuits, a plurality and preferable all eight flex circuits can be identical to one another. The flex circuits can be rotated and flipped over as appropriate in forming the transducer module. This can simplify the manufacture and/or assembly process.

In some cases, flex circuits may be provided together. For example, two flex circuits may be at least partially laminated together. This arrangement can simplify the assembly process, and reduce misalignment between two such laminated flex circuits. Referring to FIG. 20, the flex circuits can be laminated together in pairs, corresponding to which circuit connector the flex circuits will couple to. Thus, in the example of FIG. 20, the flex circuits can be laminated together in the following pairs: f and c, e and d, h and a, and g and b. An example of a portion of such a laminate is illustrated in FIG. 23. The laminate, indicated generally at 2302, comprises an upper portion 2304, comprising a flex circuit connector of one flex circuit, and a lower portion 2306, comprising a flex circuit connector of another flex circuit. The upper portion 2304 comprises connections or pads on an upper surface thereof. The lower portion 2306 comprises connections or pads on a lower surface thereof.

The connections or pads of the upper portion are provided on a base film 2308. The connections or pads of the lower portion are provided on another base film 2310. The base film 2308 and the other base film 2310 can be of the same material. The base film 2308 and/or the other base film 2310 can comprise polyimide. A suitable example material for use as the base film and/or the other base film is the Pyralux™ AP flexible circuit material marketed by DuPont™.

The two flex circuits can be laminated together by laminating both flex circuits to an intermediate layer 2312. The intermediate layer is suitably a stiffening layer. For example, the intermediate layer may have a greater Young's modulus than either of the flex circuits. This arrangement can provide additional stability to the laminate. The intermediate layer can also act as a spacing layer. This can ensure that the connections or pads of the upper portion contact the corresponding connections of the circuit connector 2102 and that the connections or pads of the lower portion contact the corresponding connections of the circuit connector 2102.

Electrodes in a single layer transducer structure may be provided with a pitch of 250 μm.

Electrodes in a two-layer transducer structure may be provided with a pitch of 500 μm.

Electrodes in a four-layer transducer structure may be provided with a pitch of 1000 μm.

The pitch of the flex circuit connector pads may be 500 μm for a single layer transducer structure. The pitch of the flex circuit connector pads may be 1000 μm for a two-layer transducer structure. The pitch of the flex circuit connector pads may be 2000 μm for a four-layer transducer structure.

The apparatus and methods described herein are particularly suitable for detecting debonding and delamination in composite materials such as carbon-fibre-reinforced polymer (CFRP). This is important for aircraft maintenance. It can also be used detect flaking around rivet holes, which can act as a stress concentrator. The apparatus is particularly suitable for applications where it is desired to image a small area of a much larger component. The apparatus is lightweight, portable and easy to use. It can readily be carried by hand by an operator to be placed where required on the object.

In one implementation, the transducer could be formed in a pen tip, for example to allow a user to run the pen over a surface for performing a simple thickness test—whether greater than a threshold or not. An LED on the pen can indicate the result.

The structures shown in the figures herein are intended to correspond to a number of functional blocks in an apparatus. This is for illustrative purposes only. The functional blocks illustrated in the figures represent the different functions that the apparatus is configured to perform; they are not intended to define a strict division between physical components in the apparatus. The performance of some functions may be split across a number of different physical components. One particular component may perform a number of different functions. The figures are not intended to define a strict division between different parts of hardware on a chip or between different programs, procedures or functions in software. The functions may be performed in hardware or software or a combination of the two. Any such software is preferably stored on a non-transient computer readable medium, such as a memory (RAM, cache, FLASH, ROM, hard disk etc.) or other storage means (USB stick, FLASH, ROM, CD, disk etc). The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device. Any of the functional units described herein might be implemented as part of the cloud.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A scanning apparatus for imaging an object, the scanning apparatus comprising:
an ultrasound transducer comprising a transmitter structure configured to transmit ultrasound signals in a first direction towards an object and a receiver structure configured to receive reflected ultrasound signals from an object;
in which the transmitter structure comprises a first transmitting element and a second transmitting element, the first and second transmitting elements being spatially offset and aligned in the first direction;
the scanning apparatus further comprising delay circuitry configured to delay the transmission of an ultrasound signal, in which the delay circuitry is configured to delay a trigger signal configured to cause a transmitting element to transmit an ultrasound signal.

2. A scanning apparatus according to claim 1, in which:
the receiver structure comprises a first receiving element and a second receiving element, the first and second receiving elements being spatially offset in the first direction, and/or each transmitting element comprises a layer of piezoelectric material and a conducting material for conducting drive signals to the transmitting element, in which the scanning apparatus is configured to couple the conducting material of the transmitting element to a signal driver for driving the piezoelectric material thereby to generate an ultrasound signal, and/or each receiving element comprises a layer of piezoelectric material and a conducting material for conducting received signals from the receiver element, in which the scanning apparatus is configured to couple the conducting material of the receiving element to a signal processor for processing of the received signals.

3. (canceled)

4. (canceled)

5. A scanning apparatus according to claim 1, in which the transducer comprises a plurality of transducer elements, each of the transducer elements comprising a respective one of the plurality of transmitting elements.

6. A scanning apparatus according to claim 5, in which:
each of the transducer elements comprises a respective one of the plurality of receiving elements, and/or the transmitting element and receiving element of one or more of the plurality of transducer elements comprise a common layer of piezoelectric material.

7. (canceled)

8. A scanning apparatus according to claim 1, in which an insulating layer is provided between each successive transmitting element in the transmitter structure, the insulating layer comprising polyimide.

9. A scanning apparatus according to claim 1, further comprising a coupling material for coupling ultrasound signals from the scanning apparatus into and out of an object, in which the coupling material comprises one or more of:
an elastomer;
a thermoplastic polymer; and
a cross-linked polymer.

10. A scanning apparatus according to claim 9, in which the scanning apparatus comprises a seal for sealing between the coupling material and the transducer.

11. A scanning apparatus according to claim 1, in which the scanning apparatus is configured to delay the transmission of an ultrasound signal from a transmitting element closer to a front of the transducer compared to the transmission of an ultrasound signal from a transmitting element further from the front of the transducer.

12. A scanning apparatus according to claim 1, in which the transmitter structure comprises a plurality of layers of transmitting elements configured to couple to a single signal driver.

13. A scanning apparatus according to claim 1, in which the transmitter structure comprises a plurality of layers of transmitting elements, in which each layer of the plurality of layers is configured to couple to a respective signal driver.

14. A scanning apparatus according to claim 13, comprising a transmitter chip per layer of the plurality of layers.

15. (canceled)

16. A scanning apparatus according to claim 1, comprising:
a flexible transmitter circuit having a transmitter circuit connector and a flexible receiver circuit having a receiver circuit connector, the flexible transmitter circuit comprising the first transmitting element; and
a plurality of circuits for coupling to the flexible circuits, each circuit comprising a respective circuit connector;
in which the transmitter circuit connector is configured to engage with a first circuit connector of a first circuit of the plurality of circuits and the receiver circuit connector is configured to engage with a second circuit connector of a second circuit of the plurality of circuits.

17. A scanning apparatus according to claim 16, in which the first circuit and the second circuit are coupled together.

18. A scanning apparatus according to claim 16, comprising:
a plurality of flexible transmitter circuits each having a respective transmitter circuit connector, the respective transmitter circuit connectors being configured to engage with the first circuit connector; and/or
a plurality of flexible receiver circuits each having a respective receiver circuit connector, the respective receiver circuit connectors being configured to engage with the second circuit connector.

19. A scanning apparatus according to claim 16, comprising a heat sink, and in which at least the first circuit of the plurality of circuits is provided adjacent the heat sink.

20. A scanning apparatus according to claim 19, in which the first circuit connector is provided on a side of the first circuit facing away from the heat sink.

21. A scanning apparatus according to claim 16, in which at least one of the transmitter circuit connector and the receiver circuit connector comprises a series of pads to enable electrical connection with conducting lines of the respective flexible circuit, the pads being provided in a staggered layout on the respective connector.

22. A scanning apparatus according to claim 16, comprising:
a plurality of flexible transmitter circuits each having electrodes thereon, in which the electrodes of one of the plurality of flexible transmitter circuits overlies gaps between the electrodes in another of the plurality of flexible transmitter circuits so as to interleave the electrodes; and/or
a plurality of flexible receiver circuits each having electrodes thereon, in which the electrodes of one of the plurality of flexible receiver circuits overlies gaps between the electrodes in another of the plurality of flexible receiver circuits so as to interleave the electrodes.

23. A scanning apparatus according to claim 16, in which flexible circuit connectors of a plurality of flexible circuits are configured to engage simultaneously with a single circuit connector.

24. A scanning apparatus according to claim 23, in which the flexible circuit connectors of the plurality of flexible circuits are laminated together, the laminated portion being configured to engage with the single circuit connector.
